(19) United States
(12) Patent Application Publication
(10) Pub. No.: US 2024/0124722 A1
(43) Pub. Date: Apr. 18, 2024

(54) PARTICULATE COMPOSITION FOR PRODUCTION OF LOW-WEAR NONSTICK COATINGS, AND COATED PRODUCT

(71) Applicant: Heidelberger Druckmaschinen AG, Heidelberg (DE)

(72) Inventor: Marina Kraft, Heidelberg (DE)

(21) Appl. No.: 18/485,392

(22) Filed: Oct. 12, 2023

(30) Foreign Application Priority Data
Oct. 18, 2022 (EP) 22202057.0

(51) Int. Cl. C09D 7/40; C09D 7/63

(52) U.S. Cl. CPC C09D 7/69; C09D 7/63

(57) ABSTRACT

A composition for producing particulate coatings for printing machine cylinders or printing machine cylinder covers that are nonstick and wear resistant. The composition includes at least one sol-gel precursor compound and a mixture of hard solid-state particles, such as silicon carbide. One type of particles has a Sauter diameter d₃₂ of between 1.0 μm and 2.0 μm and the other type of less than 1.0 μm. A mixing ratio of the two types of hard solid-state particles lies in the range from 1.5:1 to 1:1.5.

### CROSS-REFERENCE TO RELATED APPLICATION

This application claims the priority, under 35 U.S.C. § 119, of European Patent Application EP 22202057.0-1107, filed Oct. 18, 2022; the prior application is herewith incorporated by reference in its entirety.

### FIELD AND BACKGROUND OF THE INVENTION

The present invention relates to a composition for the production of particulate coatings, to the coating of surfaces with such compositions, and to a product that is coated with the composition for a printing machine.

In the variety of machines used in the graphics industry for prepress, print production and further print processing, print materials, for example paper, board or film, are conveyed and processed. The conveying of print materials in printing machines can be effected by means of rotating cylinders which, for that purpose, have print material-contacting surfaces, either in the form of coated cylinders or in the form of exchangeable covers for cylinders that are also referred to as cylinder covers or “jackets.” Two properties are generally desirable for these print material-contacting surfaces: firstly nonstick, i.e., color-repellent, varnish-repellent and soil-repellent, properties, and these surfaces should secondly be very substantially wear-resistant, such that exchange is required only infrequently. The known surface coatings for print material-contacting surfaces are generally not smooth but have a certain roughness. This is intended, inter alia, to reduce the contact area for the print material and to take better account of the surface properties mentioned with regard to nonstick properties and wear resistance.

The prior art discloses various options in principle for the production of nonstick and wear-resistant surfaces for printing machine cylinders. As well as galvanic methods, embossing methods and laser methods, thermal spraying methods and combinations thereof, it is especially also possible to employ sol-gel methods.

Compositions for producing nonstick and abrasion-resistant coatings for printing machine cylinders based on sol-gel technology using silicon oxide sols and with the addition of hard solid-state particles are described in principle in the prior art.

German published patent application DE 10 2012 004 278 A1 describes abrasion-resistant and nonstick surface coatings for printing machine cylinders based on sol-gel methods.

German published patent application DE 10 2011 010 718 A1 and its counterpart U.S. Pat. No. 9,321,078 B2 describe compositions for the production of abrasion-resistant and nonstick coatings for printing machine cylinders by means of sol-gel technology, wherein the coated surfaces comprise hard microparticles.

There is still a need for compositions comprising hard solid-state particles with which surface coatings can be produced on printing machine cylinders or surface coatings on cylinder covers for printing machine cylinders, which have not only nonstick properties but also lower abrasion and hence higher wear resistance.

### SUMMARY OF THE INVENTION

It is therefore an object of the present invention to specify compositions with which particularly wear-resistant print material-contacting surfaces comprising hard solid-state particles can be produced with simultaneously practically useful nonstick properties.

With the above and other objects in view there is provided, in according with the invention a composition for producing particulate coatings. The composition comprises:
A) at least one sol-gel precursor compound; and
B solid-state particles P1) having a Sauter diameter d₃₂ in the range from 1.0 μm to 2.0 μm, measured by dynamic light scattering; and solid-state particles P2) having a Sauter diameter d₃₂ of less than 1.0 μm, measured by dynamic light scattering;
where a ratio of solid-state particles P1) to solid-state particles P2) lies in a range between 1.5:1 and 1:1.5.

The inventors found that, surprisingly, coatings that are produced from mixtures of silicon oxide sols comprising hard solid-state particles having particle sizes of either 1-2 μm or less than 1 μm have nonstick and particularly abrasion-resistant properties when the two solid-state particle types of different size are used in about the same mixing ratio. Such particulate coatings have particularly suitable roughness parameters for practical use, in particular optimal Rp and Rk values.

The compositions of the invention can be used to produce print material-contacting particulate coatings which, because of their nonstick and particularly low-wear properties, withstand a particularly large number of print operations without wearing away. Coatings on printing machine cylinders and coated cylinder covers for printing machine cylinders can be produced comparatively easily and inexpensively with these compositions. There is no need to employ complex and costly galvanic methods, embossing methods and laser methods, or thermal spraying methods.

Accordingly, a first aspect of the present invention relates to a composition for producing particulate coatings as outlined above.

In a preferred embodiment, the solid-state particles P1) have a Sauter diameter d₃₂ in the range from 1.0 μm to 2.0 μm, measured by dynamic light scattering, and the solid-state particles P2) have a Sauter diameter d₃₂ of less than 0.5 μm, measured by dynamic light scattering. In a particularly preferred embodiment, the solid-state particles P1) have a Sauter diameter d₃₂ in the range from 1.1 μm to 1.8 μm, measured by dynamic light scattering, preferably in the range from 1.2 μm to 1.6 μm, measured by dynamic light scattering, and the solid-state particles P2) have a Sauter diameter d₃₂ of less than 0.5 μm, measured by dynamic light scattering.

In a further preferred embodiment, the solid-state particles P1) have a Sauter diameter d₃₂ in the range from 1.0 μm to 2.0 μm, measured by dynamic light scattering, and the solid-state particles P2) have a Sauter diameter d₃₂ in the range from 0.01 μm to 0.5 μm, measured by dynamic light scattering, preferably in the range from 0.05 μm to 0.5 μm, measured by dynamic light scattering. In a particularly preferred embodiment, the solid-state particles P1) have a Sauter diameter d₃₂ in the range from 1.1 μm to 1.8 μm, measured by dynamic light scattering, preferably in the range from 1.2 μm to 1.6 μm, measured by dynamic light scattering, and the solid-state particles P2) have a Sauter diameter d₃₂ in the range from 0.01 μm to 0.5 μm, measured by dynamic light scattering, preferably in the range from 0.05 μm to 0.5 μm, measured by dynamic light scattering.

The Sauter diameter d₃₂ is known in principle to the person skilled in the art. This describes the calculated diameter of theoretical spheres that are obtained by reshaping the total volume of the collective of the individual solid-state particles P1) or P2) in question theoretically to spheres of equal size which, in total, have the same volume and the same surface area as the collective of the individual solid-state particles P1) or P2) in question. The Sauter diameter d₃₂ can be determined, for example, to DIN ISO 13320 by dynamic light scattering.

The solid-state particles P1) and P2) each preferably have an aspect ratio of less than 5:1, more preferably of less than 3:1 and most preferably of less than 2:1. In a preferred embodiment, the solid-state particles P1) and P2) each have an approximately spherical structure.

According to the invention, in component B), the ratio of the solid-state particles P1) to the solid-state particles P2) is in the range from 1.5:1 to 1:1.5, preferably in the range from 1.3:1 to 1:1.3, and more preferably in the range from 1.1:1 to 1:1.1. The ratio here is understood to mean the numerical ratio. In other words, there is more preferably about the same number of solid-state particles P1) and solid-state particles P2) in component B), and at most a minor numerical surplus of one of the two solid-state particles P1) and P2).

The inventive composition for the production of particulate coatings comprises the solid-state particles P1) preferably in an amount in the range from 1% to 40% by weight, more preferably in the range from 2% to 30% by weight and most preferably in the range from 5% to 20% by weight, based on the overall composition, and the solid-state particles P2) preferably in an amount in the range from 0.5% to 35% by weight, more preferably in the range from 1% to 25% by weight and most preferably in the range from 2% to 20% by weight, based on the overall composition.

In a preferred embodiment, the amount of component B), i.e., the amount of solid-state particles P1) plus the amount of solid-state particles P2), is in the range from 2% to 50% by weight, preferably in the range from 3% to 40% by weight and more preferably in the range from 5% to 30% by weight, based on the overall composition.

The solid-state particles P1) and P2) used in the compositions of the invention are hard solid-state particles. In a preferred embodiment, the solid-state particles P1) and the solid-state particles P2) each have a Mohs hardness of 7 or more.

The solid-state particles P1) may consist wholly of the same material or be a mixture of different materials. The solid-state particles P2) may also consist wholly of the same material or be a mixture of different materials. In a preferred embodiment, the solid-state particles P1) consist wholly of an identical material. In a further preferred embodiment, the solid-state particles P2) consist wholly of an identical material. In a particularly preferred embodiment, both the solid-state particles P1) and the solid-state particles P2) consist wholly of the same material.

In a preferred embodiment, the solid-state particles P1) and the solid-state particles P2) are each independently selected from quartz particles, corundum particles, silicon carbide particles, diamond particles and mixtures thereof. In a particularly preferred embodiment, the solid-state particles P1) and the solid-state particles P2) are each selected from silicon carbide particles.

The compositions of the invention comprise, as component A), at least one sol-gel precursor compound. Precursor compounds for sol-gel processes are known in principle to the person skilled in the art. These are starting compounds for the sol-gel process. These are compounds that generally crosslink through hydrolysis and/or condensation and form gels. It is then possible by further processing steps described in principle in the prior art to produce dry surface coatings from the gels obtained.

Accordingly, in a preferred embodiment of the invention, the component A) is hydrolyzable and/or condensable. In this regard, the construct “at least one of A or B” should be understood to include A or B, as well as A and B.

In a further preferred embodiment, component A) comprises at least one of the elements B, Si, Al, Zr and Ti, preferably at least one of the elements Si and Ti. In a particularly preferred embodiment, component A) comprises the element Si.

In a further preferred embodiment, component A) comprises at least one alkoxide, preferably an alkoxide having 1 to 20 carbon atoms, more preferably having 1 to 10 carbon atoms, preferably ethoxide, propoxide or butoxide.

In a preferred embodiment, component A) comprises at least one compound selected from organic silicon compounds. In a particularly preferred embodiment, component A) comprises at least one organic silicon compound which is hydrolyzable and/or condensable.

In a further preferred embodiment, component A) comprises at least one silicon oxide sol. Silicon oxide sols are known in principle to the person skilled in the art. These are silicon-based sols that are used industrially, for example, in sol-gel processes for production of solid surface coatings from colloidal dispersions. Silicon oxide sols are described, for example, in German published patent applications DE 100 04 132 A1, DE 199 52 323 A1, and the references cited therein. Such silicon oxide sols are commercially available, for example, from FEW Chemicals GmbH, Bitterfeld-Wolfen, Germany.

In a further preferred embodiment, component A) comprises at least one compound selected from compounds of the formula (I)

R¹ₐSi(R²)₄₋ₐ (I)
wherein:
a is 1, 2 or 3,
R¹ is independently a saturated or unsaturated hydrocarbyl radical which has 1 to 20 carbon atoms and may have one or more double bonds and/or triple bonds and may be substituted or unsubstituted,
R² is independently H, halogen or OR⁴ where R⁴ is a saturated or unsaturated hydrocarbyl radical which has 1 to 20 carbon atoms and may have one or more double bonds and/or triple bonds and may be substituted or unsubstituted,
and the hydrolysis products and condensation products thereof.

In a particularly preferred embodiment, component A) comprises at least one compound selected from compounds of the abovementioned formula (I) in which
R¹ is independently C₁-C₂₀-alkyl, C₂-C₂₀-alkenyl, C₂-C₂₀-alkynyl, C₆-C₁₄-aryl, C₇-C₂₀-aralkyl, C₇-C₂₀-alkylaryl, C₈-C₂₀-arylalkenyl, C₈-C₂₀-alkenylaryl, C₈-C₂₀-arylalkynyl or C₈-C₂₀-alkynylaryl, where the R¹ radicals may bear one or more substituents selected from halogens and optionally substituted amino groups, aldehyde groups, keto groups, C₁-C₂₀-alkylcarbonyl groups, carboxy groups, mercapto groups, cyano groups, hydroxy groups, C₁-C₂₀-alkoxy groups, C₁-C₂₀-alkoxycarbonyl groups, sulfonic acid groups, phosphoric acid groups, acryloyloxy groups, methacryloyloxy groups, epoxy groups and vinyl groups,
R² is independently H, halogen, C₁-C₂₀-alkoxy, C₆-C₁₄-aryloxy or C₁-C₂₀-alkoxy-C₁-C₂₀-alkoxy,
and the hydrolysis products and condensation products thereof.

In a very particularly preferred embodiment, component A) comprises at least one compound selected from compounds of the abovementioned formula (I) in which
R¹ is independently selected from 3-aminopropyl, 3-glycidoxypropyl, 3-methacryloyloxypropyl, N-(2-aminoethyl)-3-aminopropyl, 3-mercaptopropyl, 3-isocyanatopropyl and 3-(C₁-C₂₀-alkyl)carbamatopropyl.

In a further very particularly preferred embodiment, component A) comprises at least one compound selected from compounds of the abovementioned formula (I) in which
R² is independently selected from the group consisting of chlorine, C₁-C₁₀-alkoxy, C₁-C₁₀-alkoxy-C₁-C₁₀-alkoxy, and C₆-C₁₀-aryloxy.

In a preferred embodiment, the composition of the invention includes component A) in an amount in the range from 10 to 99 mol %, preferably in the range from 20 to 90 mol %, based on the overall composition.

In a further preferred embodiment, the composition of the invention comprises component A) in an amount in the range from 10% to 99% by weight, preferably in the range from 20% to 80% by weight, based on the overall composition.

In a further preferred embodiment, the composition of the invention comprises a further component selected from component C)
C) at least one compound of the formula (II)

M(OR³)ₙ (II)
in which
   n is 2, 3 or 4,
   M is B, Al, Si, Ti or Zr,
   R³ is independently C₁-C₂₀-alkyl, C₆-C₁₄-aryl, C₁-C₂₀-acyl or C₁-C₂₀-alkoxy-C₁-C₂₀-alkyl,
and the hydrolysis products and condensation products thereof.

In a particularly preferred embodiment, the at least one compound of the formula (II) is selected from tetra-C₁-C₂₀-alkoxysilanes. In a very particularly preferred embodiment, the at least one compound of the formula (II) is selected from tetraethoxysilane, tetramethoxysilane and tetra-i-propylsilane, and is especially tetraethoxysilane.

In a preferred embodiment, the composition of the invention includes component C) in an amount in the range from 0.1 to 90 mol %, preferably in the range from 1 to 80 mol %, based on the overall composition.

In a further preferred embodiment, the composition of the invention includes component C) in an amount in the range from 1% to 90% by weight, preferably in the range from 10% to 70% by weight, based on the overall composition.

In a further preferred embodiment, the composition of the invention comprises a further component selected from component D)
D) at least one fluorinated organic compound selected from fluorinated polyethers and organic silicon compounds having at least one fluorinated side chain;
and the hydrolysis products and condensation products thereof.

In a particularly preferred embodiment, component D) comprises at least one organic silicon compound having at least one fluorinated side chain and at least one hydrolyzable silyl radical attached via a hydrocarbon chain. In a further, particularly preferred embodiment, component D) comprises fluorinated polyethers comprising structural units selected from tetrafluoroethylene oxide units and hexafluoropropylene oxide units. In a very particularly preferred embodiment, component D) comprises fluorinated polyethers comprising structural units selected from tetrafluoroethylene oxide units and hexafluoropropylene oxide units, and at least one hydrolyzable silyl radical attached via a hydrocarbon chain.

In a preferred embodiment, the composition of the invention includes component D) in an amount in the range from 0.05 to 20 mol %, preferably in an amount in the range from 1 to 10 mol %, based on the overall composition.

In a further preferred embodiment, the composition of the invention includes component D) in an amount in the range from 0.1% to 60% by weight, preferably in the range from 5% to 50% by weight, based on the overall composition.

The compositions of the invention can be produced, for example, by providing a first composition comprising a component A) and solid-state particles P1), and providing a second composition comprising a component A) and solid-state particles P2), and mixing the first composition and the second composition together, for example by stirring.

The present invention further provides for the utilization of the composition according to the invention for the coating of metal surfaces, ceramic surfaces, plastic surfaces, glass surfaces, stone surfaces, wood surfaces and combinations thereof. The resulting product is a coated product. The coating can be effected by the methods described in principle in the prior art for sol-gel coatings, for example by spraying, dipping, casting and the like.

The present invention further provides a coated product for a printing machine which at least intermittently touches a print material with a contact surface during a printing operation, wherein the contact surface has been coated at least in some regions with a composition of the invention. In a preferred embodiment, the coated product of the invention for a printing machine is an exchangeable cylinder cover for a sheet-transporting cylinder of a rotary printing machine or a sheet-transporting cylinder of a rotary printing machine.

The production of a coated product of the invention, namely an exchangeable cylinder cover, can be effected by the following procedure, for example: a smooth base plate made of stainless steel, plastic, brass or aluminum with a thickness of less than 0.5 μm is provided, which is roughened by surface grinding with a hand grinder, in order to achieve better adhesion of the overlying layers via an increase in surface volume. Alternatively, it is also possible to employ machine grinding methods, etching methods and/or laser methods. Subsequently, in order to improve the adhesion of the overlying layer, an adhesion promoter layer is applied, which can also be referred to as primer, for example by spraying. Thereafter, a composition of the invention comprising a silicon oxide sol and silicon carbide particles is applied as P1) and P2), for example by spraying. The amount of silicon carbide particles P1) and silicon carbide particles P2) used is numerically the same, i.e., they are used in a ratio of 1:1. Subsequently, the sprayed-on coating is dried thermally in the temperature range from 160 to 180° C. Thereafter, one or more layers of silicon oxide sol, preferably two layers of silicon oxide sol, are applied with no added solid-state particles, for example by spraying. These outer layers lead to even higher wear resistance of the cylinder cover. Alternatively or additionally to the outer silicon oxide sol layer, it is also possible to apply one or more layers of silicone. The outer layers applied are also dried thermally in the temperature range from 160 to 180° C. What is obtained as a result is a cylinder cover for a rotary printing machine that has to be exchanged owing to mechanical wear only after well over one million print operations.

Alternatively, it is possible to directly roughen a cylinder for a rotary printing machine, provide it with adhesion promoters, coat it with the composition of the invention and provide it with one or more outer layers by methods similar to those already specified for the cylinder cover. What is obtained as a result is then a printing machine cylinder for the transport of print sheets that wears away only after well over one million print operations and has to be exchanged out of the printing machine.

Other features which are considered as characteristic for the invention are set forth in the appended claims.

### BRIEF DESCRIPTION OF THE FIGURES

FIGS. 1-4 are high resolution photographs of cylinder covers produced by a method as described above.

FIG. 5 is a high-resolution photograph of a cylinder cover produced by a method according to the invention.

### DESCRIPTION DETAILED DESCRIPTION OF THE INVENTION

FIG. 1 shows a photograph of a cylinder cover that has been produced by the method described above. This was done using a silicon oxide sol that comprised solely solid-state particles P1), namely silicon carbide particles that had a Sauter diameter d₃₂ in the range from 1.0 μm to 2.0 μm. The surface structure was not of good suitability for practical use in the printing machine.

FIG. 2 shows a photograph of a cylinder cover that has been produced by the method described above. This was done using a silicon oxide sol that comprised solely solid-state particles P2), namely silicon carbide particles that had a Sauter diameter d₃₂ of less than 1.0 μm. The surface structure was not of good suitability for practical use in the printing machine.

FIG. 3 shows a photograph of a cylinder cover that has been produced by the method described above. This was done using a silicon oxide sol comprising silicon carbide particles, specifically a 2:1 mixture of solid-state particles P2) to solid-state particles P1). The surface structure was not of good suitability for practical use in the printing machine.

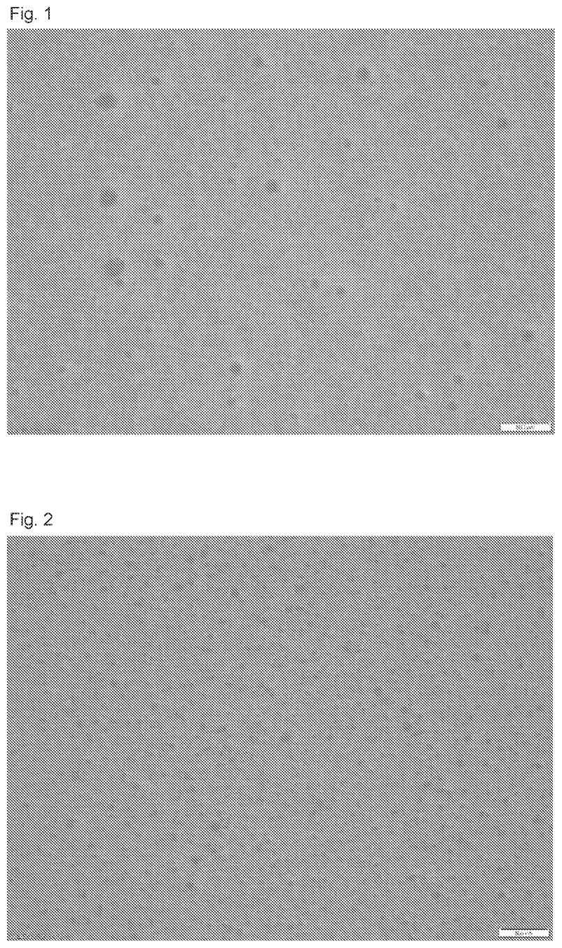

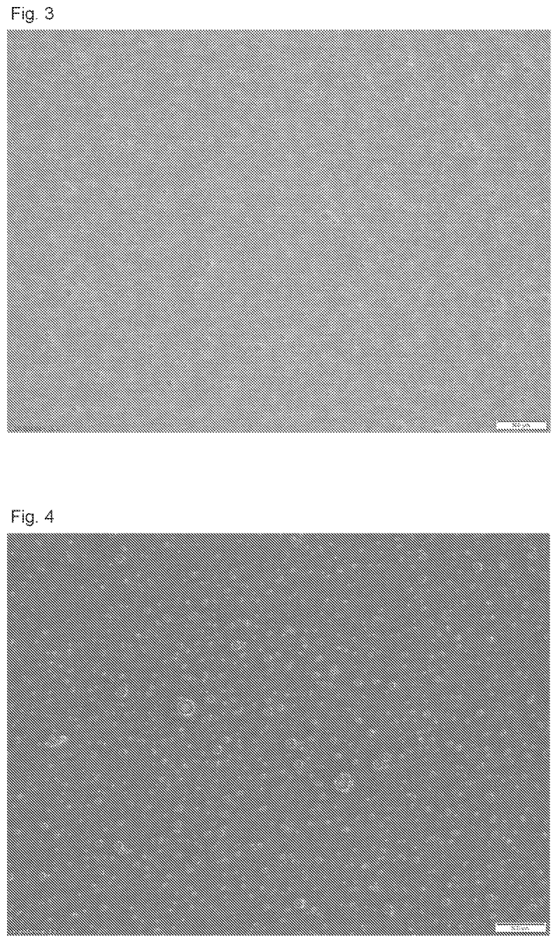

FIG. 4 shows a photograph of the cylinder cover depicted in FIG. 3, where the cylinder cover was additionally coated with a protective sol-gel layer without addition of solid-state particles. The surface structure was not of good suitability for practical use in the printing machine.

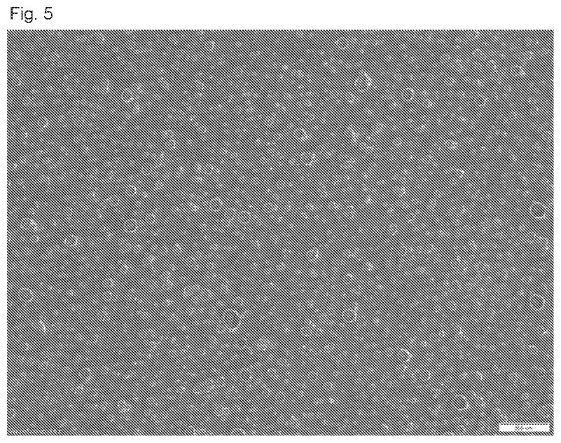

FIG. 5 shows a photograph of a cylinder cover according to the invention that has been produced by the method described above. This was done using a silicon oxide sol comprising silicon carbide particles, specifically a 1:1 mixture of solid-state particles P2) to solid-state particles P1), which was additionally coated with two protective sol-gel layers without the addition of solid-state particles. The surface structure was of very good suitability for practical use in the printing machine.

1. A composition for producing particulate coatings, comprising the following components:
A) at least one sol-gel precursor compound; and
B1) solid-state particles P1) having a Sauter diameter d₃₂ in the range from 1.0 μm to 2.0 μm, measured by dynamic light scattering; and
B2) solid-state particles P2) having a Sauter diameter d₃₂ of less than 1.0 μm, measured by dynamic light scattering; and
wherein a ratio of solid-state particles P1) to solid-state particles P2) lies in a range from 1.5:1 to 1:1.5.

2. The composition according to claim 1, wherein component A) is at least one of hydrolyzable or condensable.

3. The composition according to claim 1, wherein component A) comprises at least one element selected from the group consisting of B, Si, Al, Zr and Ti.

4. The composition according to claim 1, wherein component A) comprises at least one alkoxide.

5. The composition according to claim 1, wherein component A) comprises at least one organic silicon compound.

6. The composition according to claim 1, wherein component A) comprises at least one silicon oxide sol.

7. The composition according to claim 1, wherein component A) comprises at least one compound selected from organic silicon compounds of the formula (I)
R¹ₐSi(R²)₄₋ₐ (I)
wherein:
a is 1, 2 or 3;
R¹ is independently a saturated or unsaturated hydrocarbyl radical which has 1 to 20 carbon atoms and may have one or more double bonds and/or triple bonds and may be substituted or unsubstituted;
R² is independently H, halogen or OR⁴, where R⁴ is a saturated or unsaturated hydrocarbyl radical which has 1 to 20 carbon atoms and may have one or more double bonds and/or triple bonds and may be substituted or unsubstituted; and
hydrolysis products and condensation products thereof.

8. The composition according to claim 7, wherein component A) comprises at least one compound selected from compounds of the formula (I), in which:
R¹ is independently C₁-C₂₀-alkyl, C₂-C₂₀-alkenyl, C₂-C₂₀-alkynyl, C₆-C₁₄-aryl, C₇-C₂₀-aralkyl, C₇-C₂₀-alkylaryl, C₈-C₂₀-arylalkenyl, C₈-C₂₀-alkenylaryl, C₈-C₂₀-arylalkynyl or C₈-C₂₀-alkynylaryl, where the R¹ radicals may bear one or more substituents selected from halogens and optionally substituted amino groups, aldehyde groups, keto groups, C₁-C₂₀-alkylcarbonyl groups, carboxy groups, mercapto groups, cyano groups, hydroxy groups, C₁-C₂₀-alkoxy groups, C₁-C₂₀-alkoxycarbonyl groups, sulfonic acid groups, phosphoric acid groups, acryloyloxy groups, methacryloyloxy groups, epoxy groups and vinyl groups;
R² is independently H, halogen, C₁-C₂₀-alkoxy, C₆-C₁₄-aryloxy or C₁-C₂₀-alkoxy-C₁-C₂₀-alkoxy; and
the hydrolysis products and condensation products thereof.

9. The composition according to claim 1, wherein an amount of component A) lies in a range from 20% to 80% by weight, based on an overall composition.

10. The composition according to claim 1, wherein the solid-state particles P1) and the solid-state particles P2) each have a Mohs hardness of 7 or more.

11. The composition according to claim 10, wherein the solid-state particles P1) and the solid-state particles P2) are each independently selected from quartz particles, corundum particles, silicon carbide particles, diamond particles, and mixtures thereof,

12. The composition according to claim 10, wherein the solid-state particles P1) and the solid-state particles P2) are mixtures of silicon carbide particles.

13. The composition according to claim 1, wherein the amount of component B) is in the range from 5% to 30% by weight, based on the overall composition.

14. A coated surface, comprising:
a composition according to claim 1 forming a coating on a metal surface, a ceramic surface, a plastic surface, a glass surface, a stone surface, a wood surface, or combinations thereof.

15. A coated product for a printing machine, the coated product comprising a contact surface that has been coated, at least in some region thereof, with a composition according to claim 1, and wherein the contact surface is configured to at least intermittently touch a print material during a printing operation.

16. The coated product according to claim 15, being an exchangeable cylinder cover for a sheet-transporting cylinder of a rotary printing machine or a sheet-transporting cylinder for a rotary printing machine.
